(19) United States
(12) Patent Application Publication
(10) Pub. No.: US 2023/0021234 A1
(43) Pub. Date: Jan. 19, 2023

(54) Reactive resin component, reactive resin system containing said component, and use of said component

(71) Applicant: Hilti Aktiengesellschaft, Schaan (LI)

(72) Inventors: Gerald Gaefke, Kaufbeuren (DE); Memet-Emin Kumru, Augsburg (DE); Ana-Maria Martin-Lasanta, Landsberg am Lech (DE); Frescilia Octa-Smolin, Huglfing (DE); Jacqueline Kissel, Landsberg am Lech (DE)

(73) Assignee: Hilti Aktiengesellschaft, Schaan (LI)

(21) Appl. No.: 17/757,371

(22) PCT Filed: Dec. 7, 2020
(86) PCT No.: PCT/EP2020/084876

§ 371 Date: Jun. 15, 2022

(30) Foreign Application Priority Data
Dec. 18, 2019 (EP) 19217615.4

(51) Int. Cl. C08K 9/06; C08L 63/00; C08L 33/10

(52) U.S. Cl. CPC C08K 9/06; C08L 63/00; C08L 33/10

(57) ABSTRACT

A reactive resin component contains at least one radically curable unsaturated compound and at least one silanized filler. The proportion of all inorganic solids in the reactive resin component is at least 60 wt. % and the proportion of the at least one silanized filler, which has a grain diameter of 4 μm or smaller, is 0.5 to 60 wt. %, based on the reactive resin component. The reactive resin component can be used in a reactive resin system.

The invention relates to a reactive resin component for a reactive resin system, to a reactive resin system containing said component, and to the use of the reactive resin component for chemical fastening.

### BACKGROUND

The use of chemical fastening agents based on radically curable resins has long been known. In the field of fastening technology, the use of resins as an organic binder for chemical fastening technology, e.g. as a constituent of an anchor mass (“chemical anchor”), has prevailed. Anchor masses of this kind are composite masses which are packaged as multicomponent systems, usually two-component systems, with one component (the reactive resin component) containing the radically curable resin and the other component (the hardener component) containing an initiator (for radical formation). Other common constituents such as additives, fillers, accelerators, inhibitors, solvents, and reactive diluents can be contained in one and/or the other component. By mixing the two components, the curing reaction, i.e. the polymerization, is initiated by radical formation and the resin is cured to obtain duromers.

The anchor masses are used for fastening anchoring means in boreholes in various substrates and for structural bonding. The anchoring means should offer the highest possible resistance to axial tension, i.e. high pull-out values. Such high pull-out values are advantageous in application, since higher loads can be supported or the embedding depth can be reduced. The latter has the advantage that it saves material and time for the user.

A high proportion of high-viscosity or solid, radically curable compounds, also often referred to as solid resin, generally contributes to higher pull-out values. However, the proportion of solid resin is limited in two ways: a higher proportion above a particular amount tends to have a disadvantage in that the shrinkage increases during curing, and a high solid resin proportion inevitably leads to a high viscosity of the components. Nevertheless, a sufficiently low viscosity is necessary in order to enable a high proportion of solid fillers and thus to enable the lowest possible shrinkage during curing of the mass. In contrast, it must be ensured that the mass can be ejected and injected into the borehole without excessive exertion of force.

However, a high proportion of solid fillers is usually at the expense of the ejection forces.

There is therefore a need to set a high degree of filling for radically curable systems without adversely affecting the viscosity of the system, and to increase the performance of the system.

### DESCRIPTION OF THE INVENTION

This object is achieved by the reactive resin component described herein, which component has a high degree of filling and a particular content of silanized fillers, and by a reactive resin system containing this reactive resin component.

The invention relates firstly to a reactive resin component comprising at least one radically curable unsaturated compound and at least one filler made of oxides of silicon, which filler is modified with a silane that has reactive groups capable of participating in the polymerization with the radically curable unsaturated compound, and comprising optionally other different inorganic additives, characterized in that the proportion of all inorganic solids in the reactive resin component is at least 60 wt. % and in that the proportion of the at least one filler made of oxides of silicon, which filler is modified with a silane that has reactive groups capable of participating in the polymerization with the radically curable unsaturated compound, and which has a grain diameter of 4 μm or smaller, is 0.5 to 60 wt. %, preferably 1 to 50 wt. %, particularly preferably 2.75 to 26 wt. %, based on the reactive resin component.

The invention relates secondly to a reactive resin system comprising a reactive resin component (A) according to the invention and a hardener component (B) which contains a curing agent (such as a peroxide) for curing the reactive resin. Components (A) and (B) are packaged so as to be spatially separated from one other until use of the reactive resin system, so that a reaction takes place only when the two components are brought into contact with one other.

The invention relates thirdly to the use of a reactive resin component according to the invention and/or of a reactive resin system according to the invention for chemically fastening anchoring means in boreholes or for structural bonding.

The invention relates fourthly to the use of a combination of (a) a filler made of oxides of silicon, which filler is modified with a silane that has reactive groups capable of participating in the polymerization with the radically curable unsaturated compound, the proportion of the at least one filler made of oxides of silicon, which filler is modified with a silane that has reactive groups capable of participating in the polymerization with the radically curable unsaturated compound, and which has a grain diameter of 4 μm or smaller, being 0.5 to 60 wt. %, based on the reactive resin component containing this filler, and (b) at least one compound having at least two carbon-carbon double bonds, the weight-average molecular weight of which per carbon-carbon double bond (WPU) is greater than 225 g/mol and the viscosity of which is less than 2500 mPa·s (measured in accordance with DIN 53019 at 25° C.), in a reactive resin component and/or a reactive resin system for chemical fastening in order to increase the performance of the reactive resin component and/or the reactive resin system.

In order to better understand the invention, the following explanations of the terminology used herein are considered to be useful. Within the meaning of the invention:
a “reactive resin” is a usually solid or high-viscosity “radically curable,” i.e. polymerizable, compound, which cures by means of polymerization and forms a resin matrix; the reactive resin is the reaction product of a bulk reaction per se; this also includes the reaction batch for producing the backbone resin after the reaction has ended, which backbone resin is present without the product being isolated and therefore can contain the reactive resin, a reactive diluent, a stabilizer and a catalyst, if used, in addition to the radically curable compound;
“reactive diluents” are liquid or low-viscosity monomers and oligomers which dilute the reactive resin and thereby give it the viscosity required for its application, contain one or more functional groups capable of reacting with the reactive resin and are predominantly constituents of the cured mass (resin matrix) in the polymerization (curing);
“WPU” is the weight-average molecular weight per carbon-carbon double bond. i.e. the theoretical value that results when the molecular weight (g) of the radically curable, ethylenically unsaturated compound is divided by the number of reactive double bonds in the radically curable, ethylenically unsaturated compound, such as a methacrylate function;
“curing agents” are substances that cause the polymerization (curing) of the reactive resin;
an “inhibitor” is also a compound capable of inhibiting the polymerization reaction (curing), which compound is used to prevent the polymerization reaction and thus undesired premature polymerization of the reactive resin during storage (in this function often also referred to as a stabilizer) and/or to delay the start of the polymerization reaction immediately after adding the curing agent; the role of the inhibitor depends on the quantities in which it is used;
an “accelerator” is a compound capable of accelerating the polymerization reaction (curing), which compound is used to accelerate the formation of radicals;
a “filler” is an organic or inorganic, in particular inorganic, compound that can be passive and/or reactive and/or functional; “passive” means that the compound is surrounded unchanged by the curing resin matrix; “reactive” means that the compound polymerizes into the resin matrix and forms an expanded network with the reactive resin: “functional” means that the compound is not polymerized into the resin matrix but fulfills a particular function in the formulation, “additives” also being referred to in this case;
a “resin composition” is a mixture of the reactive resin and inorganic and/or organic additives and fillers, such as an inhibitor and/or an accelerator;
a “curing agent composition” is a mixture of the curing agent and inorganic and/or organic fillers, such as a phlegmatizer, i.e. a stabilizer for the curing agent;
a “highly filed curing agent composition” means that the curing agent composition has a predominant amount of fillers, in particular inorganic fillers, and thus a high degree of filling of over 50 vol. % of fillers;
a “silanized filler” is a filler, in particular an inorganic filler, such as quartz powder or the like, which has been surface-treated with a silane;
a “two-component reactive resin system” is a reactive resin system comprising two separately stored components, generally a reactive resin component containing the resin composition and a hardener component containing the curing agent composition, so that curing of the reactive resin takes place only after the two components have been mixed;
a “multi-component reactive resin system” is a reactive resin system comprising a plurality of separately stored components, so that curing of the reactive resin takes place only after all of the components are mixed;
“(meth)acrylic . . . / . . . (meth)acrylic . . . ” means both the “methacrylic . . . / . . . methacrylic . . . ” compounds and the “acrylic . . . / . . . acrylic . . . ” compounds; “methacrylic . . . / . . . methacrylic . . . ” compounds are preferred in the present invention;
“a” or “an” as the article preceding a class of chemical compounds, e.g. preceding the word “reactive diluent,” means that one or more compounds included in this class of chemical compounds, e.g. various “reactive diluents,” may be intended;
“at least one” means numerically “one or more”; in a preferred embodiment, this term numerically means “one”;
“contain,” “comprise” and “include” mean that more constituents may be present in addition to the mentioned constituents; these terms are meant to be inclusive and therefore also include “consist of”; “consist of” is meant exclusively and means that no other constituents may be present: in a preferred embodiment, the terms “contain,” “comprise” and “include” mean the term “consist of”;
a range limited by numbers means that the two extreme values and any value within this range are disclosed individually.

All standards cited in this text (e.g. DIN standards) were used in the version that was current on the filing date of this application.

### Silanized Fillers

According to the invention, the reactive resin component contains a filler made of oxides of silicon, which filler is modified with a silane that has reactive groups capable of participating in the polymerization with the radically curable unsaturated compound.

Oxides of silicon are primarily silicon dioxide, in particular quartz, silicates and the like.

The filler is preferably selected from the group consisting of silicon dioxide in the additional presence of one or more oxides selected from oxides from the group of metals, which in particular consists of calcium, titanium, iron, sodium or the like, the filler in particular being selected from the group consisting of quartz or silicates.

According to the invention, the silane used to modify the fillers has on the one hand at least one Si-bonded hydrolyzable group, such as alkoxy (e.g. having 1 to 7 carbon atoms) or halogen, such as chloro, and at least one group that is reactive with respect to the radically curable unsaturated compound used, such as carbon-carbon double bonds, for example in (meth)acrylate groups. These fillers are also referred to herein as “silanized fillers.”

The silanes can, for example, be selected from the group consisting in particular of (meth)acryloyloxypropyltrialkoxysilanes, such as 3-(meth)acryloyloxypropyltrimethoxysilane and 3-(meth)acryloyloxypropyltriethoxysilane and/or alkenylalkoxysilanes such as vinyltrimethoxysilane or vinyltriethoxysilane; or mixtures of two or more thereof. The silanes are preferably selected from the group consisting of 3-(meth)acryloyloxypropyltrialkoxysilanes and alkenylalkoxysilanes, and more preferably from the group of (meth)acryloyloxypropyltrialkoxysilanes.

The silanes from the group consisting of 3-(meth)acryloyloxypropyltrimethoxysilane, 3-(meth)acryloyloxypropyltriethoxysilane, 3-(meth)acryloyloxymethyltrmethoxysilane, 3-(meth)acryloyloxymethyltriethoxysilane, vinyltrimethoxysilane, vinyltriethoxysilane, tetraethoxysilane, tetramethoxysilane and tetrapropoxysilane are particularly preferred.

According to the invention, these silanized fillers are selected such that the proportion of silanized fillers having a grain diameter of 4 μm or less is 0.5 to 60 wt. %, preferably 1 to 50 wt. % and particularly preferably 2.75 to 26 wt. %, based on the reactive resin component which contains these fillers. The amount of particles having a grain diameter of 4 μm or smaller can be taken from the grain size distribution provided by the manufacturers of the fillers.

It is also conceivable for the fillers to be modified with the silanes only after the reactive resin component has been produced. For this purpose, the reactive resin component has a filler that is not modified with silanes and also a silane including at least one Si-bonded hydrolyzable group as an additive, the silane being as just described and the filler being as just described.

### Aggregates (Additives and Fillers)

According to one embodiment, the reactive resin component can contain other different inorganic aggregates, such as fillers and/or other additives, with the proviso that their surface is not modified with silanes that have reactive groups capable of participating in the polymerization with the radically curable unsaturated compound.

The fillers used are conventional fillers, preferably mineral or mineral-like fillers, such as quartz, glass, sand, quartz sand, quartz powder, porcelain, corundum, ceramics, talc, silica (e.g. fumed silica), silicates, clay, titanium dioxide, chalk, barite, feldspar, basalt, aluminum hydroxide, granite or sandstone, polymeric fillers such as thermosets, hydraulically curable fillers such as gypsum, quicklime or cement (e.g. alumina cement or Portland cement), metals such as aluminum, carbon black, and also wood, mineral or organic fibers, or the like, or mixtures of two or more thereof, which can be added as powder, in the form of granules or in the form of shaped bodies. The fillers may be present in any desired forms, for example as powder, or as shaped bodies, for example in cylindrical, annular, spherical, platelet, rod, saddle or crystal form, or else in fibrous form (fibrillar fillers), and the corresponding base particles preferably have a maximum diameter of 10 mm. However, the globular, inert substances (spherical form) have a preferred and more pronounced reinforcing effect.

Further rheological additives, such as optionally organically after-treated fumed silica, bentonites, alkyl- and methylcelluloses, castor oil derivatives or the like, plasticizers, such as phthalic acid esters or sebacic acid esters, stabilizers, antistatic agents, thickeners, flexibilizers, curing catalysts, rheology aids, wetting agents, coloring additives, such as dyes or in particular pigments, for example for different staining of the components for improved control of the mixing thereof, or the like, or mixtures of two or more thereof, are also possible conceivable additives.

### Degree of Filling

According to the invention, the proportion of all inorganic and organic solids in the multi-component reactive resin system/in the first component is at least 60 wt. %, in particular 60 to 90 wt. %, preferably 60 to 85 wt. %, more preferably 65 to 85 wt. %, even more preferably 65 to 80 wt. % and especially preferably 65 to 75 wt. %, in each case based on the reactive resin component.

As already mentioned above, the proportion of the at least one filler made of oxides of silicon, which filler is modified with a silane that has reactive groups capable of participating in the polymerization with the radically curable unsaturated compound, i.e. the silanized filler, having a grain diameter of 4 μm or smaller, is 0.5 to 60 wt. %, preferably 1 to 50 wt. % and particularly preferably 2.75 to 26 wt. %, in each case based on the reactive resin component.

The presence of the silanized fillers allows the reactive resin component to go beyond the standard degree of filling used in commercial products, without this having negative effects on the properties of the mortar composition, such as viscosity and the associated ejection forces or mixing quality, as well as of the cured mortar composition, such as shrinkage or performance.

### Hydraulically Setting Compound

In one embodiment of the invention, in addition to the radically curable compound present, the reactive resin component also contains a hydraulically setting or polycondensable inorganic compound, in particular cement. Such hybrid mortar systems are described in detail in DE 4231161 A1. In this case, the reactive resin component preferably contains, as a hydraulically setting or polycondensable inorganic compound, cement, for example Portland cement or aluminate cement, with cements which are free of transition metal oxide or have a low level of transition metal being particularly preferred. Gypsum, as such or in a mixture with the cement, can also be used as a hydraulically setting inorganic compound. The reactive resin component may also comprise siliceous, polycondensable compounds, in particular soluble, dissolved and/or amorphous-silica-containing substances such as fumed silica, as the polycondensable inorganic compound.

The reactive resin system can contain the hydraulically setting or polycondensable compound in an amount of 0 to 40 wt. %, preferably 5 to 30 wt. %, particularly preferably 10 to 30 wt. %, based on the reactive resin component.

If hydraulically setting or polycondensable compounds are present in the reaction system, the total amount of fillers is in the range mentioned above. Accordingly, the total amount of fillers, including the hydraulically setting and polycondensable compounds, is at least 60 wt. %, in particular 60 to 90 wt. %, preferably 65 to 85 wt. %, more preferably 65 to 85 wt. %, more preferably 65 to 80 wt. % and even more preferably 65 to 75 wt. %, in each case based on the reactive resin component.

### Radically Curable Unsaturated Compound

Suitable radically curable unsaturated compounds that can be used both as a reactive resin and as a reactive diluent are those that are usually described for reactive resin systems to be used for chemical fastening.

Radically curable compounds that are suitable as a reactive resin are unsaturated compounds, compounds having carbon-carbon triple bonds, and thiol-yne/ene resins, as are known to a person skilled in the art.

The radically curable unsaturated compound, the reactive resin, is particularly preferably a compound based on urethane (meth)acrylate, based on epoxy (meth)acrylate, a methacrylate of an alkoxylated bisphenol or based on other unsaturated compounds.

Of these compounds, the group of unsaturated compounds is preferred, which group comprises styrene and derivatives thereof, (meth)acrylates, vinyl esters, unsaturated polyesters, vinyl ethers, allyl ethers, itaconates, dicyclopentadiene compounds and unsaturated fats, of which unsaturated polyester resins and vinyl ester resins are particularly suitable and are described, for example, in applications EP 1 935 860 A1, DE 195 31 649 A1, WO 02/051903 A1 and WO 10/108939 A1. Vinyl ester resins (synonym: (meth)acrylate resins) are in this case most preferred due to the hydrolytic resistance and excellent mechanical properties thereof. Vinyl ester urethane resins, in particular urethane methacrylates, are very particularly preferred. These include, as preferred resins, the urethane methacrylate resins described in DE 10 2011 017 626 B4. In this regard, DE 10 2011 017 626 B4, and above all its description of the composition of these resins, in particular in the examples of DE 10 2011 017 626 B4, is hereby incorporated by reference.

Examples of suitable unsaturated polyesters which can be used according to the invention are divided into the following categories, as classified by M. Malik et al, in J. M. S.—Rev. Macromol. Chem. Phys., C40 (2 and 3), pp. 139-165 (2000):

(1) ortho-resins: these are based on phthalic anhydride, maleic anhydride or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol A;

(2) iso-resins: these are prepared from isophthalic acid, maleic anhydride or fumaric acid and glycols. These resins can contain higher proportions of reactive diluents than the ortho-resins;

(3) bisphenol A fumarates: these are based on ethoxylated bisphenol A and fumaric acid;

(4) HET acid resins (hexachloroendomethylene tetrahydrophthalic acid resins): these are resins obtained from chlorine/bromine-containing anhydrides or phenols during the preparation of unsaturated polyester resins.

In addition to these resin classes, what are referred to as dicyclopentadiene resins (DCPD resins) can also be distinguished as unsaturated polyester resins. The class of DCPD resins is either obtained by modifying one of the above-mentioned resin types by means of a Diels-Alder reaction with cyclopentadiene, or said resins are alternatively obtained by means of a first reaction of a dicarboxylic acid, for example maleic acid, with dicyclopentadienyl and then by means of a second reaction of the usual preparation of an unsaturated polyester resin, the latter being referred to as a DCPD maleate resin.

The unsaturated polyester resin preferably has a molecular weight Mn in the range of 500 to 10,000 daltons, more preferably in the range of 500 to 5,000 and even more preferably in the range of 750 to 4,000 (according to ISO 13885-1). The unsaturated polyester resin has an acid value in the range of 0 to 80 mg KOH/g resin, preferably in the range of 5 to 70 mg KOH/g resin (according to ISO 2114-2000). If a DCPD resin is used as the unsaturated polyester resin, the acid value is preferably 0 to 50 mg KOH/g resin.

In the context of the invention, vinyl ester resins are oligomers, prepolymers or polymers having at least one (meth)acrylate end group, what are referred to as (meth)acrylate-functionalized resins, which also include urethane (meth)acrylate resins and epoxy (meth)acrylates.

Vinyl ester resins, which have unsaturated groups only in the end position, are obtained, for example, by reacting epoxy oligomers or epoxy polymers (for example bisphenol A digylcidyl ether, phenol novolac-type epoxies or epoxy oligomers based on tetrabromobisphenol A) with (meth)acrylic acid or (meth)acrylamide, for example. Preferred vinyl ester resins are (meth)acrylate-functionalized resins and resins which are obtained by reacting an epoxy oligomer or epoxy polymer with methacrylic acid or methacrylamide, preferably with methacrylic acid, and optionally with a chain extender, such as diethylene glycol or dipropylene glycol. Examples of such compounds are known from applications U.S. Pat. Nos. 3,297,745 A, 3,772,404 A. 4,618,658 A, GB 2 217 722 A1, DE 37 44 390 A1 and DE 41 31 457 A1.

Particularly suitable and preferred vinyl ester resins are (meth)acrylate-functionalized resins, which are obtained, for example, by reacting difunctional and/or higher-functional isocyanates with suitable acrylic compounds, optionally with the help of hydroxy compounds that contain at least two hydroxyl groups, as described for example in DE 3940309 A1. Very particularly suitable and preferred are the urethane methacrylate resins (which are also referred to as vinyl ester urethane resins) described in DE 10 2011 017 626 B4, the composition of which is incorporated herein by reference.

Aliphatic (cyclic or linear) and/or aromatic di- or higher-functional isocyanates or prepolymers thereof can be used as isocyanates. The use of such compounds increases wettability and thus improves the adhesive properties. Aromatic difunctional or higher functional isocyanates or prepolymers thereof are preferred, aromatic difunctional or higher functional prepolymers being particularly preferred. Toluylene diisocyanate (TDI), diisocyanatodiphenylmethane (MDI) and polymeric diisocyanatodiphenylmethane (pMDI) for increasing chain stiffening, and hexane diisocyanate (HDI) and isophorone diisocyanate (IPDI), which improve flexibility, may be mentioned by way of example, of which polymeric diisocyanatodiphenylmethane (pMDI) is very particularly preferred.

Suitable acrylic compounds are acrylic acid and acrylic acids substituted on the hydrocarbon group, such as methacrylic acid, hydroxyl-containing esters of acrylic or methacrylic acid with polyhydric alcohols, pentaerythritol tri(meth)acrylate, glycerol di(meth)acrylate, such as trimethylolpropane di(meth)acrylate or neopentyl glycol mono(meth)acrylate. Acrylic or methacrylic acid hydroxyalkyl esters, such as hydroxyethyl (meth)acrylate, hydroxypropyl (meth)acrylate, polyoxyethylene (meth)acrylate, polyoxypropylene (meth)acrylate, are preferred, especially since such compounds sterically prevent the saponification reaction. Because of its lower alkali stability, acrylic acid is less preferred than acrylic acids substituted on the hydrocarbon radical.

Hydroxy compounds that can optionally be used are suitable dihydric or higher alcohols, for example secondary products of ethylene or propylene oxide, such as ethanediol, di- or triethylene glycol, propanediol, dipropylene glycol, other diols, such as 1,4-butanediol, 1,6-hexanediol, neopentyl glycol, diethanolamine, further bisphenol A or F or the ethoxylation/propoxylation and/or hydrogenation or halogenation products thereof, higher alcohols such as glycerol, trimethylolpropane, hexanetriol and pentaerythritol, hydroxyl-group-containing polyethers, for example oligomers of aliphatic or aromatic oxiranes and/or higher cyclic ethers, such as ethylene oxide, propylene oxide, styrene oxide and furan, polyethers which contain aromatic structural units in the main chain, such as those of bisphenol A or F, hydroxyl-group-containing polyesters based on the above-mentioned alcohols or polyethers and dicarboxylic acids or the anhydrides thereof, such as adipic acid, phthalic acid, tetra- or hexahydrophthalic acid, heteric acid, maleic acid, fumaric acid, itaconic acid, sebacic acid and the like. Particularly preferred are hydroxy compounds having aromatic structural units to reinforce the chain of the resin, hydroxy compounds containing unsaturated structural units, such as fumaric acid, to increase the crosslinking density, branched or star-shaped hydroxy compounds, in particular trihydric or higher alcohols and/or polyethers or polyesters containing the structural units thereof, branched or star-shaped urethane (meth)acrylates to achieve lower viscosity of the resins or their solutions in reactive diluents and higher reactivity and crosslinking density.

The vinyl ester resin preferably has a molecular weight Mn in the range of 500 to 3,000 daltons, more preferably 500 to 1,500 daltons (according to ISO 13885-1). The vinyl ester resin has an acid value in the range of 0 to 50 mg KOH/g resin, preferably in the range of 0 to 30 mg KOH/g resin (according to ISO 2114-2000).

All of these reactive resins that can be used according to the invention as radically curable unsaturated compounds can be modified according to methods known to a person skilled in the art, for example to achieve lower acid numbers, hydroxide numbers or anhydride numbers, or can be made more flexible by introducing flexible units into the backbone, and the like.

In addition, the reactive resin may contain other reactive groups that can be polymerized with a radical initiator, such as peroxides, for example reactive groups derived from itaconic acid, citraconic acid and allylic groups and the like.

In one embodiment, the reactive resin component of the reactive resin system contains, in addition to the reactive resin, at least one other low-viscosity, radically polymerizable unsaturated compound as the reactive diluent. This is expediently added to the reactive resin and is therefore contained in the reactive resin component.

In particular low-viscosity, radically curable unsaturated compounds that are suitable as reactive diluents are described in applications EP 1 935 860 A1 and DE 195 31 649 A1. The reactive resin system preferably contains a (meth)acrylic acid ester as a reactive diluent, with (meth)acrylic acid esters being particularly preferably selected from the group consisting of hydroxypropyl (meth)acrylate, propanediol-1,3-di(meth)acrylate, butanediol-1,2-di(meth)acrylate, trimethylolpropane tri(meth)acrylate, 2-ethylhexyl (meth)acrylate, phenylethyl (meth)acrylate, tetrahydrofurfuryl (meth)acrylate, ethyl triglycol (meth)acrylate, N,N-dimethylaminoethyl (meth)acrylate, N,N-dimethylaminomethyl (meth)acrylate, butanediol-1,4-di(meth)acrylate, butanediol-1,3-di(meth)acrylate, hexanediol-1,6-di(meth)acrylate, acetoacetoxyethyl (meth)acrylate, ethanediol-1,2-di(meth)acrylate, isobornyl (meth)acrylate, di-, tri- or oligoethylene glycol di(meth)acrylate, methoxypolyethylene glycol mono(meth)acrylate, trimethylcyclohexyl(meth)acrylate, 2-hydroxyethyl(meth)acrylate, dicyclopentenyloxyethyl (meth)acrylate and/or tricyclopentadienyl di(meth)acrylate, bisphenol A (meth)acrylate, novolac epoxy di(meth)acrylate, di[(meth)acryloyl-maleoyl]tricyclo-5.2.1.0.^{2,6}-decane, dicyclopentenyloxyethyl crotonate, 3-(meth)acryloyloxymethyltricylo-5.2.1.0.^{2,6}-decane, 3-(meth)cyclopentadienyl (meth)acrylate, isobornyl (meth)acrylate and decalyl 2-(meth)acrylate. Biogenic reactive diluents such as tetrahydrofurfuryl (meth)acrylate, isobornyl (meth)acrylate or isosorbide di(meth)acrylate are preferred.

The reactive diluent can be used alone or as a mixture consisting of two or more reactive diluents.

In principle, other conventional radically polymerizable compounds, alone or in a mixture with the (meth)acrylic acid esters described in the preceding paragraph, can also be used, e.g. styrene, α-methylstyrene, alkylated styrenes, such as tert-butylstyrene, divinylbenzene and vinyl and allyl compounds. Examples of vinyl or allyl compounds of this kind are hydroxybutyl vinyl ether, ethylene glycol divinyl ether, 1,4-butanediol divinyl ether, trimethylolpropane divinyl ether, trimethylolpropane trivinyl ether, mono-, di-, tri-, tetra- and polyalkylene glycol vinyl ether, mono-, di-, tri-, tetra- and polyalkylene glycol allyl ether, adipic acid divinyl ester, trimethylolpropane diallyl ether and trimethylolpropane triallyl ether.

Particularly preferred reactive diluents are the reactive diluents used in the examples.

The reactive resin system can contain radically curable unsaturated compound in an amount of 10 to 40 wt. %, preferably 15 to 35 wt. %, particularly preferably 25 to 35 wt. %, based on the reactive resin component. The radically curable compound can be either a reactive resin based on a radically curable compound or a reactive diluent or a mixture of a reactive resin with two or more reactive diluents.

In cases where the radically curable unsaturated compound is a reactive resin mixture, the amount of the mixture which can be contained in the reactive resin system corresponds to the amount of the radically curable compound, specifically from 10 to 40 wt. %, preferably 15 to 35 wt. %, particularly preferably 25 to 35 wt. %, based on the reactive resin component, the proportion of the reactive resin being 0 to 100 wt. %, preferably 30 to 70 wt. %, based on the reactive resin mixture, and the proportion of the reactive diluent or a mixture consisting of a plurality of reactive diluents being 0 to 100 wt. %, preferably 30 to 70 wt. %.

The total amount of the radically curable compound depends on the degree of filling, i.e. the amount of inorganic fillers, including the other inorganic aggregates and the hydraulically setting or polycondensable compounds, provided that these are contained in the reactive resin component.

In a preferred embodiment of the invention, the at least one radically curable compound is a compound or a mixture of a plurality of compounds. The compound or the compounds of the mixture are selected from the groups described in more detail above in such a way that one of the following conditions is met, the conditions being defined by the groups (i) to (iv):
(i) 35 wt. % or more, preferably 37 wt. % or more, in each case based on the reactive resin component, of a compound having a weight-average molecular weight per carbon-carbon double bond (WPU) greater than 230 g/mol and a viscosity greater than 2500 mPa·s (measured in accordance with DIN 53019 at 25° C.), or
(ii) 30 wt. % or more, preferably 33 wt. % or more, in each case based on the reactive resin component, of a compound having a weight-average molecular weight per carbon-carbon double bond (WPU) greater than 230 g/mol and a viscosity greater than 2500 mPa·s (measured in accordance with DIN 53019 at 25° C.) and 10 wt. % or more, based on the reactive resin component, of a compound having a weight-average molecular weight per carbon-carbon double bond (WPU) greater than 125 g/mol and a viscosity less than 2500 mPa·s (measured in accordance with DIN 53019 at 25° C.), or
(iii) 57 wt. % or more, preferably 60 wt. % or more, in each case based on the reactive resin component, of a compound having a weight-average molecular weight per carbon-carbon double bond (WPU) greater than 225 g/mol and a viscosity less than 2500 mPa·s (measured in accordance with DIN 53019 at 25° C.), or
(iv) 50 wt. % or more, preferably 53 wt. % or more, in each case based on the reactive resin component, of a compound having a weight-average molecular weight per carbon-carbon double bond (WPU) greater than 225 g/mol and a viscosity less than 2500 mPa·s (measured in accordance with DIN 53019 at 25° C.) and 10 wt. % or more, based on the reactive resin component, of a compound having a weight-average molecular weight per carbon-carbon double bond (WPU) greater than 125 g/mol and a viscosity less than 2500 mPa·s (measured in accordance with DIN 53019 at 25° C.).

Compounds having at least two carbon-carbon double bonds which meet condition (i), that is to say fall into group (i), are in particular compounds based on urethane (meth)acrylate, based on epoxy (meth)acrylate, a methacrylate of alkoxylated bisphenols or based on other ethylenically unsaturated compounds.

Compounds having at least two carbon-carbon double bonds which meet the second of condition (ii) or the second condition (iv) are compounds having a weight-average molecular weight per carbon-carbon double bond (WPU) greater than 125 g/mol and a viscosity less than 2500 mPa·s (measured in accordance with DIN 53019 at 25° C.). These can be mixed with the compounds from group (i) and/or (iii).

These compounds are preferably (meth)acrylic acid esters which are selected from the following group: propanediol-1,3-di(meth)acrylate, butanediol-1,2-di(meth)acrylate, trimethylolpropane tri(meth)acrylate, butanediol-1,4-di(meth)acrylate, butanediol-1.3-di(meth)acrylate, hexanediol-1,6-di(meth)acrylate, ethanediol-1,2-di(meth)acrylate, tricyclopentadienyl di(meth)acrylate, bisphenol A di(meth)acrylate, novolac epoxy di(meth)acrylate, di-[(meth)acryloyl maleoyl] tricyclo-5.2.1.0.^{2,6}-decane and ethoxylated glycol dimethacrylate.

Compounds having at least two carbon-carbon double bonds which meet condition (iii), that is to say fall into group (iii), are in particular di-, tri- or oligoethylene glycol di(meth)acrylates, preferably di-, tri- and tetraethylene glycol di(meth)acrylate.

By using tricyclodecane dimethanol diacrylate, ethoxylated bisphenol A dimethacrylate, in particular two, three or four times ethoxylated bisphenol A dimethacrylate, and ethoxylated glycol dimethacrylate in combination with the silanized fillers, the performance of the cured composition increased not only in high strength concrete, such as C50/60, but also in concrete with lower compressive strength, such as C20/25 concrete.

Compounds listed above which do not meet conditions (i) to (iv) or do not fall into one of groups (i) to (iv) can additionally be used. In particular, low-viscosity compounds are used in order to set the viscosity of the reactive resin component and/or, optionally, to dissolve the solid, radically curable compounds and make said compounds available.

### Accelerator

In another embodiment, the reactive resin system also contains at least one accelerator. This accelerates the curing reaction.

Suitable accelerators are known to a person skilled in the art. These are expediently amines.

Suitable amines are selected from the following compounds, which are described in application US 2011071234 A1, for example: dimethylamine, trimethylamine, ethylamine, diethylamine, triethylamine, n-propylamine, di-n-propylamine, tri-n-propylamine, isopropylamine, diisopropylamine, triisopropylamine, n-butylamine, isobutylamine, tert-butylamine, di-n-butylamine, diisobutylamine, triisobutylamine, pentylamine, isopentylamine, diisopentylamine, hexylamine, octylamine, dodecylamine, laurylamine, stearylamine, aminoethanol, diethanolamine, triethanolamine, aminohexanol, ethoxyaminoethane, dimethyl(2-chloroethyl)amine, 2-ethylhexylamine, bis(2-chloroethyl)amine, 2-ethylhexylamine, bis(2-ethylhexyl)amine, N-methylstearylamine, dialkylamines, ethylenediamine, N,N′-dimethylethylenediamine, tetramethylethylenediamine, diethylenetriamine, permethyldiethylenetriamine, triethylenetetramine, tetraethylenepentamine, 1,2-diaminopropane, di-propylenetriamine, tripropylenetetramine, 1,4-diaminobutane, 1,6-diaminohexane, 4-amino-1-diethylaminopentane, 2,5-diamino-2,5-dimethylhexane, trimethylhexamethylenediamine, N,N-dimethylaminoethanol, 2-(2-diethylaminoethoxy)ethanol, bis(2-hydroxyethyl)oleylamine, tris[2(2-hydroxyethoxy)ethyl]amine, 3-amino-1-propanol, methyl(3-aminopropyl)ether, ethyl(3-aminopropyl)ether, 1,4-butanediol-bis(3-aminopropyl ether), 3-dimethylamino-1-propanol, 1-amino-2-propanol, 1-diethylamino-2-propanol, di-iso-propanolamine, methyl-bis(2-hydroxypropyl)amine, tris(2-hydroxypropyl)amine, 4-amino-2-butanol, 2-amino-2-methylpropanol, 2-amino-2-methylpropanediol, 2-amino-2-hydroxymethylpropanediol, 5-diethylamino-2-pentanone, 3-methylaminopropionitrile, 6-aminohexanoic acid, 11-aminoundecanoic acid, 6-aminohexanoic acid ethyl ester, 11-aminohexanoate-isopropyl ester, cyclohexylamine, N-methylcyclohexylamine. N,N-dimethylcyclohexylamine, dicyclohexylamine, N-ethylcyclohexylamine, N-(2-hydroxyethyl)cyclohexylamine, N,N-bis(2-hydroxyethyl)cyclohexylamine, N-(3-aminopropyl)cyclohexylamine, aminomethylcyclohexane, hexahydrotoluidine, hexahydrobenzylamine, aniline, N-methylaniline, N,N-dimethylaniline, N,N-diethylaniline, N,N-di-propylaniline, iso-butylaniline, toluidine, diphenylamine, hydroxyethylaniline, bis(hydroxyethyl)aniline, chloroaniline, aminophenols, aminobenzoic acids and esters thereof, benzylamine, dibenzylamine, tribenzylamine, methyldibenzylamine, α-phenylethylamine, xylidine, di-iso-propylaniline, dodecylaniline, aminonaphthalene, N-methylaminonaphthalene, N,N-dimethylaminonaphthalene, N,N-dibenzylnaphthalene, diaminocyclohexane, 4,4′-diamino-dicyclohexyl methane, diamino-dimethyl-dicyclohexyl methane, phenylenediamine, xylylenediamine, diaminobiphenyl, naphthalenediamines, benzidines, 2,2-bis(aminophenyl)propane, aminoanisoles, aminothiophenols, aminodiphenyl ethers, aminocresols, morpholine, N-methylmorpholine, N-phenylmorpholine, hydroxyethylmorpholine, N-methylpyrrolidine, pyrrolidine, piperidine, hydroxyethylpiperidine, pyrroles, pyridines, quinolines, indoles, indolenines, carbazoles, pyrazoles, imidazoles, thiazoles, pyrimidines, quinoxalines, aminomorpholine, dimorpholineethane, [2,2,2]-diazabicyclooctane and N,N-dimethyl-p-toluidine.

Preferred amines are symmetrically or asymmetrically substituted aniline and toluidine derivatives and N,N-bis(hydroxy)alkylarylamines, such as N,N-dimethylaniline, N,N-diethylaniline, N,N-dimethyl-p-toluidine, N,N-bis(hydroxyalkyl)arylamine, N,N-bis(2-hydroxyethyl)aniline, N,N-bis(2-hydroxyethyl)toluidine, N,N-bis(2-hydroxypropyl)aniline, N,N-bis(2-hydroxypropyl)toluidine, N,N-bis(3-methacryloyl-2-hydroxypropyl)-p-toluidine, N,N-dibutoxyhydroxypropyl-p-toluidine, N-methyl-N-hydroxyethyl-p-toluidine, N-ethyl-N-hydroxyethyl-p-toluidine and the analogous o- or m-toluidines and 4,4′-bis(dimethylamino)diphenylmethane and/or the leuco forms of the dyes crystal violet or malachite green.

Polymeric amines, such as those obtained by polycondensation of N,N-bis(hydroxyalkyl)aniline with dicarboxylic acids or by polyaddition of ethylene oxide and these amines, are also suitable as accelerators.

Preferred accelerators are N,N-bis(2-hydroxypropyl)toluidine, N,N-bis(2-hydroxyethyl)toluidine and para-toluidine ethoxylate (Bisomer® PTE).

The reactive resin system can contain the accelerator in an amount of 0.01 to 10 wt. %, preferably 0.5 to 5 wt. %, particularly preferably 0.5 to 3 wt. %, based on the reactive resin component.

### Inhibitors

In yet another embodiment, the reactive resin component also contains an inhibitor both for the storage stability of the reactive resin and the reactive resin component and for setting the gel time. The reactive resin system can contain the inhibitor alone or together with the accelerator. A suitably balanced accelerator-inhibitor combination is preferably used to set the processing time or gel time.

The inhibitors which are conventionally used for radically polymerizable compounds, as are known to a person skilled in the art, are suitable as inhibitors. The inhibitors are preferably selected from phenolic compounds and non-phenolic compounds, such as stable radicals and/or phenothiazines.

Phenols, such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), 1,3,5-trimethyl-2,4,6-tris(3,5-di-tert-butyl-4-hydroxybenzyl)benzene, 2,2′-methylene-di-p-cresol, pyrocatechol and butylpyrocatechols such as 4-tert-butylpyrocatechol, 4,6-di-tert-butylpyrocatechol, hydroquinones such as hydroquinone, 2-methylhydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methylbenzoquinone, 2,6-dimethylbenzoquinone, naphthoquinone, or mixtures of two or more thereof, are suitable as phenolic inhibitors.

Phenothiazines, such as phenothiazine and/or derivatives or combinations thereof, or stable organic radicals, such as galvinoxyl radicals and N-oxyl radicals, are preferably taken into consideration as non-phenolic or anaerobic inhibitors, i.e. inhibitors that are active even without oxygen, in contrast to the phenolic inhibitors.

Examples of N-oxyl radicals that can be used are those described in DE 199 56 509. Suitable stable N-oxyl radicals (nitroxyl radicals) can be selected from 1-oxyl-2,2,6,6-tetramethylpiperidine, 1-oxyl-2,2,6,6-tetramethylpiperidin-4-ol (also referred to as TEMPOL), 1-oxyl-2,2,6,6-tetramethylpiperidin-4-one (also referred to as TEMPON), 1-oxyl-2,2,6,6-tetramethyl-4-carboxy-piperidine (also known as 4-carboxy-TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL), aluminum-N-nitrosophenylhydroxylamine, diethylhydroxylamine. Further suitable N-oxyl compounds are oximes, such as acetaldoxime, acetone oxime, methyl ethyl ketoxime, salicyloxime, benzoxime, glyoximes, dimethylglyoxime, acetone-O-(benzyloxycarbonyl)oxime and the like.

These compounds are particularly useful and mostly necessary because otherwise the desired storage stability of preferably more than 3 months, in particular 6 months or more, cannot be achieved. The UV stability and in particular the storage stability can be increased considerably in this way.

Furthermore, pyrimidinol or pyridinol compounds substituted in para-position to the hydroxyl group, as described in patent DE 10 2011 077 248 B1, can be used as inhibitors.

Preferred inhibitors are 1-oxyl-2,2,6,6-tetramethylpiperidine (TEMPO) and 1-oxyl-2,2,6,6-tetramethylpiperidin-4-ol (TEMPOL), catechols, particularly preferably tert-butyl-pyrocatechol and pyrocatechol the desired properties are achieved by means of the functional group (in comparison with the reactive diluents otherwise used), BHT and phenothiazine.

The inhibitors can be used either alone or as a combination of two or more thereof, depending on the desired properties of the reactive resin system. The combination of the phenolic and the non-phenolic inhibitors enables a synergistic effect, as is also shown by the setting of a substantially drift-free setting of the gel time of the reactive resin composition.

The reactive resin system can contain the inhibitor in an amount of 0.001 to 5 wt. %, preferably 0.01 to 3 wt. %, particularly preferably 0.05 to 1 wt. %, based on the reactive resin component. If a plurality of inhibitors is contained, the amount just mentioned corresponds to the total amount of inhibitors.

The combination of a silicon-oxide-based silanized filler and the radically curable compound, in particular the radically curable compound from group (iii) described above, is advantageously used in a reactive resin system for chemical fastening in order to increase the filler content and the performance, i.e. the load values.

Accordingly, the invention also relates to the use of a combination of (a) a filler made of oxides of silicon, which filler is modified with a silane that has reactive groups capable of participating in the polymerization with the radically curable unsaturated compound, and comprising optionally other different inorganic additives, the proportion of the at least one filler made of oxides of silicon, which filler is modified with a silane that has reactive groups capable of participating in the polymerization with the radically curable unsaturated compound, and which has a grain diameter of 4 μm or smaller, being 0.5 to 60 wt. %, preferably 1 to 50 wt. %, and particularly preferably 2.75 to 26 wt. %, in each case based on a reactive resin component, and (b) at least one compound having at least two carbon-carbon double bonds, the weight-average molecular weight of which per carbon-carbon double bond (WPU) is greater than 225 g/mol and the viscosity of which is less than 2500 mPa·s (measured in accordance with DIN 53019 at 25° C.), in a reactive resin component and/or a reactive resin system for chemical fastening in order to increase the performance of the reactive resin component and/or the reactive resin system.

The reactive resin component according to the invention can advantageously be used as a resin component in a multi-component reactive resin system, which also includes two-component reactive resin systems.

The invention accordingly also relates to a multi-component reactive resin system comprising the above-described reactive resin component and a hardener component.

The hardener component contains at least one initiator, i.e. a curing agent for the radically curable unsaturated compound.

### Hardener Component

### Curing Agent for Radically Curable Unsaturated Compound

Any of the peroxides known to a person skilled in the art that can be used to cure methacrylate resins can be used. Such peroxides include organic and inorganic peroxides, either liquid or solid. Examples of suitable peroxides are peroxycarbonates (of formula —OC(O)OO—), peroxyesters (of formula —C(O)OO—), diacyl peroxides (of formula —C(O)OOC(O)—), dialkyl peroxides (of formula —OO—) and the like. These may be present as oligomers or polymers. A comprehensive range of examples of suitable peroxides is described, for example, in application US 2002/0091214 A1, paragraph [0018].

The peroxides are preferably selected from the group of organic peroxides. Suitable organic peroxides are: tertiary alkyl hydroperoxides such as tert-butyl hydroperoxide and other hydroperoxides such as cumene hydroperoxide, peroxyesters or peracids such as tert-butyl peresters (e.g. tert-butyl peroxybenzoate), benzoyl peroxide, peracetates and perbenzoates, lauroyl peroxide including (di)peroxyesters, perethers such as peroxy diethyl ether, and perketones such as methyl ethyl ketone peroxide. The organic peroxides used as curing agents are often tertiary peresters or tertiary hydroperoxides, i.e. peroxide compounds having tertiary carbon atoms which are bonded directly to an —O—O-acyl or —OOH group. However, mixtures of these peroxides with other peroxides can also be used according to the invention. The peroxides may also be mixed peroxides, i.e. peroxides which have two different peroxide-carrying units in one molecule. Preferably, benzoyl peroxide or dibenzoyl peroxide (BPO) or tert-butyl peroxybenzoate is used for curing.

In particular, persulfates, perborates and/or perphosphates, such as ammonium persulfate, potassium and sodium monopersulfates or potassium and sodium dipersulfates, can be used as inorganic peroxides. However, hydrogen peroxide can also be used.

The use of organically substituted ammonium persulfates (for example N′N′N′N′-tetrabutylammonium or N′-capryl-N′N′N′-trimethylammonium persulfate is also possible.

In addition to the peroxide, the curing agent composition according to the invention also contains a phlegmatizer in order to stabilize the peroxide. Corresponding phlegmatizers are known from DE 3226602 A1, EP 0432087 A1 and EP 1 371 671 A1.

The curing agent composition preferably contains water as the phlegmatizer. In addition to the water, the curing agent composition can also contain other phlegmatizers, water being preferred as the sole phlegmatizer in order not to introduce any compounds which have a plasticizing effect.

The peroxide is preferably present as a suspension together with the water. Corresponding suspensions are commercially available in different concentrations, for example the aqueous dibenzoyl peroxide suspensions from United Initiators (BP40SAQ), Perkadox 40L-W (Nouryon), Luperox® EZ-FLO (Arkema) and Peroxan BP40W (Pergan).

The reactive resin system can contain the peroxide in an amount of 2 to 50 wt. %, preferably 5 to 45 wt. %, particularly preferably 10 to 40 wt. %, based on the curing agent composition.

In addition to water and the curing agent, the hardener component can also contain other additives, specifically emulsifiers, antifreeze agents, buffers and/or rheological additives, and/or fillers.

Suitable emulsifiers are: ionic, nonionic or amphoteric surfactants; soaps, wetting agents, detergents; polyalkylene glycol ethers; salts of fatty acids, mono- or diglycerides of fatty acids, sugar glycerides, lecithin; alkanesulfonates, alkylbenzenesulfonates, fatty alcohol sulfates, fatty alcohol polyglycol ethers, fatty alcohol ether sulfates, sulfonated fatty acid methyl esters; fatty alcohol carboxylates; alkyl polyglycosides, sorbitan esters, N-methylglucamides, sucrose esters; alkylphenols, alkylphenol polyglycol ethers, alkylphenol carboxylates; quaternary ammonium compounds, esterquats, and carboxylates of quaternary ammonium compounds.

Suitable antifreeze agents are: organic or inorganic, water-soluble additives that lower the freezing temperature of the water; mono-, bi- or higher-functional alcohols such as ethanol, n-propanol or isopropanol, n-, iso- or tert-butanol, etc.; ethylene glycol, 1,2- or 1,3-propylene glycol, glycerol, trimethylol propane, etc., oligo- or polyglycols such as dialkylene glycols, trialkylene glycols, etc.; sugars, in particular mono- or disaccharides; trioses, tetroses, pentoses and hexoses in their aldehyde or keto form and the analogous sugar alcohols. Examples include, but are not limited to, glyceraldehyde, fructose, glucose, sucrose, mannitol, etc.

Suitable buffers are organic or inorganic acid/base pairs that stabilize the pH value of the hardener component, such as acetic acid/alkali acetate, citric acid/monoalkali citrate, monoalkali/dialkali citrate, dialkali/trialkali citrate, combinations of mono-, di- and/or tri-basic alkali phosphates, optionally with phosphoric acid; ammonia with ammonium salts; carbonic acid-bicarbonate buffers, etc. Intramolecular buffers, referred to as Good buffers, such as 4-(2-hydroxyethyl)-1-piperazineethanesulfonic acid (HEPES) or 2-(N-morpholino)ethanesulfonic acid (MES) as well as tris(hydroxymethyl)aminomethane (TRIS) etc., can also be used.

The flow properties are set by adding thickening substances, also known as rheological additives. Suitable rheological additives are: phyllosilicates such as laponites, bentones or montmorillonite, Neuburg siliceous earth, fumed silicas, polysaccharides; polyacrylate, polyurethane or polyurea thickeners and cellulose esters. Wetting agents and dispersants, surface additives, defoamers & deaerators, wax additives, adhesion promoters, viscosity reducers or process additives can also be added for optimization.

The fillers used are conventional fillers, preferably mineral or mineral-like fillers, such as quartz, glass, sand, quartz sand, quartz powder, porcelain, corundum, ceramics, talc, silica (e.g. fumed silica), silicates, clay, titanium dioxide, chalk, barite, feldspar, basalt, aluminum hydroxide, granite or sandstone, polymeric fillers such as thermosets, hydraulically curable fillers such as gypsum, quicklime or cement (e.g. alumina cement or Portland cement), metals such as aluminum, carbon black, and also wood, mineral or organic fibers, or the like, or mixtures of two or more thereof, which can be added as powder, in the form of granules or in the form of shaped bodies. The fillers may be present in any desired forms, for example as powder, or as shaped bodies, for example in cylindrical, annular, spherical, platelet, rod, saddle or crystal form, or else in fibrous form (fibrillar fillers), and the corresponding base particles preferably have a maximum diameter of 10 mm. However, the globular, inert substances (spherical form) have a preferred and more pronounced reinforcing effect.

The fillers are preferably present in the hardener component in an amount of up to 80, in particular 0 to 60, above all 0 to 50 wt. %.

In a particularly preferred embodiment, the constituents of the reactive resin component according to the invention are one or more of the constituents which are mentioned in the examples according to the invention. Reactive resin components which contain the same constituents or consist of the same constituents as are mentioned in the individual examples according to the invention, preferably approximately in the proportions stated in said examples, are very particularly preferred.

The reactive resin components according to the invention can be used in many fields in which unsaturated polyester resins, vinyl ester resins or vinyl ester urethane resins are otherwise conventionally used. They can be used in particular for preparing reactive resin mortars for construction applications, such as chemical fastening.

The reactive resin component according to the invention is usually used in a two-component system consisting of a reactive resin component (A) and a hardener component (B). This multi-component system may be in the form of a cartridge system or a film pouch system. In the intended use of the system, the components are either ejected from the cartridges or film pouches under the application of mechanical forces or by gas pressure, are mixed together, preferably by means of a static mixer through which the constituents are passed, and introduced into the borehole, after which the devices to be fastened, such as threaded anchor rods and the like, are introduced into the borehole which is provided with the curing reactive resin, and are adjusted accordingly.

Such a reactive resin system is used primarily in the construction sector, for example for the repair of concrete, as polymer concrete, as a coating composition based on synthetic resin or as a cold-curing road marking. Said system is particularly suitable for chemically fastening anchoring means, such as anchors, reinforcing bars, screws and the like, in boreholes, in particular in boreholes in various substrates, in particular mineral substrates, such as those based on concrete, aerated concrete, brickwork, limestone, sandstone, natural stone, glass and the like, and metal substrates such as those made of steel. In one embodiment, the substrate of the borehole is concrete, and the anchoring means consists of steel or iron. In another embodiment, the substrate of the borehole is steel, and the anchoring means consists of steel or iron.

The invention also relates to the use of the reactive resin component according to the invention and/or a reactive resin system as a constituent of a curable binder or as a curable binder, in particular for fastening anchoring means in boreholes of various substrates and for structural bonding. In one embodiment, the substrate of the borehole is concrete, and the anchoring means consists of steel or iron.

The invention is explained in greater detail in the following with reference to a number of examples. All examples and drawings support the scope of the claims. However, the invention is not limited to the specific embodiments shown in the examples and drawings.

### EXAMPLES

Unless stated otherwise, all constituents of the compositions that are listed here are commercially available and were used in the usual commercial quality.

Unless stated otherwise, all % data given in the examples relate to the total weight of the composition described, as a calculation basis.

List of the Constituents Used in the Examples and References (Explanation of Abbreviations) as Well as their Trade Names and Sources of Supply:

| Raw material | Comment | Company manufacturer |
|---|---|---|
| SILBOND ® 600 | Quart?. powder, surface treated with methacrylsilane; | Quarzwerke GmbH, |
| MST | d₅₀ = 4 μm; 55 wt. % of particles < 4 μm; bulk density | Ferchen |
| | (DIN EN ISO 60) 0.6 g/cm³; specific surface area | |
| | (DIN ISO 9277) BET 3.0 m²/g | |
| SIKRON ® SF800 | Fine quartz powder, surface treated with | Quarzwerke GmbH, |
| | methacrylsilane: d₅₀ = 4 μm; 78 wt. % of particles | Ferchen |
| | < 4 μm; bulk density (DIN EN ISO 60) 0.42 g/cm³; | |
| | specific surface area (DIN ISO 9277) BET 6.0 m²/g | |
| SIKRON ® SF500 | Fine quartz powder, surface treated with | Quarzwerke GmbH, |
| | methacryisilane; d₅₀ = 2 μm; 55 wt. % of particles | Ferchen |
| | < 4 μm; bulk density (DIN EN ISO 60) 0.58 g/cm³; | |
| | specific surface area (DIN ISO 9277) BET 3.9 m²/g | |
| modified SIKRON ® | SIKRON ® SF500 treated with methacryisilane | See below |
| SF500 | | |
| modified SIKRON ® | SIKRON ® SF800 treated with methacrylsilane | See below |
| SF800 | | |
| F32 | Quartz sand F32 | Quarzwerke GmbH, |
| | | Ferchen |
| UMA | Urethane methacrylate, prepared from an isomer | prepared according to |
| | mixture diphenylmethane diisocyanate, dipropylene | EP 0713015 A1 |
| | glycol and HPMA | |
| mUMA | Urethane methacrylate prepared from 4,4′- | prepared according to |
| | diphenylmethane diisocyanate, dipropylene glycol | EP 3424968 A1 |
| | and HPMA | (compound (V)) |
| TUMA | Urethane methacrylate prepared from toluene-2,4- | prepared according to |
| | diisocyanate and HPMA | EP 3424968 A1 |
| | | (compound (IV)) |
| XUMA | Urethane methacrylate prepared from 1,3-xylylene | prepared according to |
| | diisocyanate and HPMA | EP 3424972 A1 |
| | | (compound (V)) |
| HPMA | 2-hydroxypropyl methacrylate | EvonikAG |
| BDDMA | 1,4-butanediol dimethacrylate | Evonik Degussa GmbH |
| TCDDMA | Tricyclodecane dimethanol dimethacrylate | Sartomer Europe |
| E2BADMA | doubly ethoxylated bisphenol A dimethacrylate | Sartomer Europe |
| E3BADMA | triethoxylated bisphenol A dimethacrylate | Sartomer Europe |
| E4BADMA | tetraethoxylated bisphenol A dimethacrylate | Sartomer Europe |
| HDDMA | 1,6 hexanediol dimethacrylate | Evonik AG |
| PEG200DMA | Polyethylene glycol 200 dimethacrylate | Evonik AG |
| DIPPT | Di-iso-propyl-p-toluidine | Saitigo |
| Pyrocatechol (BC) | 1,2-dihydroxybenzene | Rhodia |
| TBC | 4-tert-butylpyrocatechol | Rhodia |

Preparation of Modified SIKRON® SF800 (Mod. SIKRON® SF800) or SIKRON® SF500 (mod. SIKRON® SF500)

In a 1-liter plastic beaker, 584 g of quartz powder (e.g. SIKRON® SF800, SIKRON® SF500) are mixed with 12 g of 3-(meth)acryloyloxypropyltrimethoxysilane and premixed for 15 minutes in a tumble mixer. A mixture of 0.36 g of triethylamine and 3.6 g of fully deionized water is then added to the quartz powder and mixed for 2 hours in a tumble mixer. Finally, the quartz flour is left to dry at 50° C. for 36 hours.

In order to check the quality of the modification, the quartz powder is extracted with petroleum spirit and the extract is examined by means of IR spectroscopy. The quality is considered satisfactory if no more 3-(meth)acryloyloxypropyltrimethoxysilane or the condensation products thereof can be seen in the extract.

### Determination of the Viscosity of the Radically Curable Unsaturated Compounds

The dynamic viscosity of the reactive resins was measured using a cone-and-plate measuring system in accordance with DIN 53019. The diameter of the cone was 60 mm for samples smaller than 200 mPas and 20 mm for samples larger than 20 mPas. The opening angle is 1°. Measurement was carried out at a constant shear rate of 150/s and a temperature of 25° C. (unless indicated otherwise in the measurement data). The measuring time was 180 s and a measuring point was generated every second. In order to reach the shear rate, a ramp of 0-150/s with a duration 30 of 120 s was connected upstream. Since these are Newtonian liquids, a linear evaluation over the measured section was made at a constant shear rate of 150/s over the measured section and the viscosity was determined.

Radically curable unsaturated compounds having at least carbon-carbon double bonds used in the example formulations, their calculated WPU and their viscosity range:

| | WPU | Viscosity range |
|---|---|---|
| | [g/mol] | [mPas, 25° C.] |
| UMA* | 333 | >2500 |
| mUMA* | 269 | >2500 |
| TUMA* | 231 | >2500 |
| XU MA* | 238 | >2500 |
| bisGMA* | 270 | >2500 |
| 1 4-BDDMA | 113 | <2500 |
| 1,6-HDDMA | 127 | <2500 |
| TCDDM.A | 161 | <2500 |
| PEG200DMA | 165 | <2500 |
| E2BADMA | 226 | <2500 |
| E3BADMA | 248 | <2500 |
| E4BADMA | 286 | <2500 |

*Cannot be measured at room temperature using the method mentioned due to the very high viscosity. Values estimated.

### Measurement of Bond Stress

First, reactive resin components (A) having the constituents given in Tables 1 and 2, the amounts of which used can also be found in Tables 1 and 2, were prepared by first mixing all soluble constituents and stirring until a homogeneous mixture was formed. All of the insoluble constituents were then added and pre-stirred by hand. Finally, a dissolver of type LDV 0.3-1 was mixed in the dissolver under vacuum using a PC laboratory system.

The composition was stirred for 8 minutes at 3500 rpm under vacuum (p s 100 mbar) using a 55 mm dissolver disk and an edge scraper.

A reactive resin system consisting of the reactive resin components (A) from Tables 1 and 2 and the commercial hardener component HY-200 B (Hilti) used as the hardener component (B) were filled into a plastic cartridge (Ritter GmbH; volume ratio A:B=5:1) having the inner diameters 32.5 mm (component (A)) and 14 mm (component (B)), and tested as follows:

In order to determine the bond stresses of the cured fastening compositions. M12 anchor threaded rods were inserted into boreholes in C20/25 or C50/60 concrete having a diameter of 14 mm and a borehole depth of 60 mm, which boreholes were filled with the fastening compositions. These were cleaned, dust-free, dry, hammer-drilled holes. The fastening compositions were ejected out of the cartridges via a static mixer (HIT-RE-M mixer; Hilti Aktiengesellschaft) and injected into the boreholes. The curing took place at 20° C. The temperature of the two-component reactive resin system or of the fastening composition was 20° C. when setting. The bond stresses were determined by centrally pulling out the threaded anchor rods, a support for the concrete of 18 mm diameter being used. In each case, five anchor threaded rods were placed and after 24 hours of curing, the load values were determined and the bond stress was calculated.

The bond stresses (N/mm²) determined in this way are listed in Table 1 below as an average of five measurements.

The bond stresses for the measurements in C50/60 concrete are given in Table 1 and the bond stresses for the measurements in C20/25 concrete are given in Table 2.

As can be seen from Table 1, the bond stresses increase due to the addition of the silanized fillers in the high-strength concrete. It can be seen from Table 2 that the use of radically curable compounds from group (iii), in particular TCDDMA, E2BADMA, E4BADMA, PEG200DMA and HDDMA, also increases the bond stresses in concrete having low compressive strength.

TABLE 1
Bond stress τ in C50/60 concrete

| Example | Ref. 1 | Ref. 2 | Ref. 3 | Ref. 4 | 1 | 2 | 3 | 4 |
|---|---|---|---|---|---|---|---|---|
| SIKRON ® SF800 | | | | 5 | | | | |
| SILBOND ® 600 MST | | | | | | 15 | 22.1 | |
| mod. SIKRON ® SF800 | | | | | 5 | | | 22.1 |
| F32 | 44.2 | 36.7 | 38.7 | 39.2 | 39.2 | 23.7 | 22.1 | 22.1 |
| UMA | 12.9 | | | | | | 12.9 | 12.9 |
| mUMA | | 17.2 | 16.4 | 14.1 | 14.1 | | | |
| TUMA | | | | | | | | |
| XUMA | | | | | | 17.3 | | |
| HPMA | 6.9 | 6.4 | 6.1 | 5.3 | 5.3 | 5.3 | 6.9 | 6.9 |
| BDDMA | 13.8 | 17.2 | 16.4 | 14.1 | 14.1 | 11.0 | 13.9 | 13.9 |
| TCDDMA | | | | | | | | |
| DIPPT + pyrocatechol + TBC | 0.9 | 1.1 | 1.1 | 0.9 | 0.9 | 0.9 | 0.9 | 0.9 |
| Degree of filling*) [wt. %] | 65.5 | 58 | 60 | 65.5 | 65.5 | 60 | 65.5 | 65.5 |
| τ [N/mm²] | 35.7 | 36.0 | 37.3 | 37.5 | 39.3 | 39.1 | 40.5 | 40.7 |
| Example | 5 | 6 | 7 | 8 | 9 | 10 | 11 | 12 |
| SIKRON ® SF800 | | | | | | | | |
| SILBOND ® 600 MST | 15 | 15 | 15 | 24.5 | 15 | 15 | 15 | 15 |
| mod. SIKRON ® SF800 | | | | | | | | |
| F32 | 29.2 | 29.2 | 29.2 | 24.5 | 34.1 | 34.1 | 29.2 | 34.1 |
| UMA | | | | 11.2 | | | | |
| mUMA | 14.1 | | | | 12.3 | | 13.2 | 11.4 |
| TUMA | | 15.5 | 13.5 | | | | | |
| XUMA | | | | | | 20 | | |
| HPMA | 5.3 | 5.3 | 4.6 | 6 | 4.6 | 6.1 | 6.1 | 5.3 |
| BDDMA | 14.1 | 12.8 | 11.1 | 12 | 12.3 | 12.8 | 9.6 | 8.3 |
| TCDDMA | | | | | | | 10 | 8.6 |
| DIPPT + pyrocatechol + TBC | 0.9 | 0.9 | 0.8 | 0.8 | 0.8 | 1.1 | 1.1 | 0.9 |
| Degree of filling*) [wt. %] | 65.5 | 65.5 | 65.5 | 70 | 70 | 70 | 65.5 | 70 |
| τ [N/mm²] | 39.1 | 38.7 | 39.6 | 39.3 | 39.3 | 39.2 | 39.2 | 40.4 |

*)Total amount of all inorganic solids

TABLE 2
Bond stress τ in C20/25 concrete

| Example | Ref. 5 | 13 | 14 | 15 | 16 | 17 | 18 | 19 | 20 | 21 | 22 | 23 | 24 | 25 |
|---|---|---|---|---|---|---|---|---|---|---|---|---|---|---|
| SILBOND ® 600 MST | | 22.1 | | 15 | 15 | 15 | 24.5 | 24.5 | 24.5 | 24.5 | 24.5 | 15 | 10 | 5 |
| mod. SIKRON ® SF800 | | | 15 | | | | | | | | | | | |
| F32 | 44.2 | 22.1 | 34.1 | 34.1 | 34.1 | 34.1 | 24.5 | 24.5 | 24.5 | 24.5 | 24.5 | 34.1 | 39 | 44 |
| UMA | 12.9 | | 11.2 | | | | | | | | | | | |
| mUMA | | 12.9 | | | | 12.3 | 9.9 | 9.9 | 11.1 | 11.1 | 9.9 | 9.9 | 9.9 | 9.9 |
| TUMA | | | | 13.5 | | | | | | | | | | |
| XUMA | | | | 15 | | | | | | | | | | |
| HPMA | 6.9 | 6.9 | 6 | 4.6 | 4.6 | 4.6 | 4.6 | 4.6 | 4.6 | 4.6 | 4.6 | 4.6 | 4.6 | 4.6 |
| BDDMA | 13.8 | 13.8 | 12 | 9.6 | 11.1 | 12.3 | 3.3 | 7.2 | 6 | 6 | 7.2 | 7.2 | 7.2 | 7.2 |
| TCDDMA | | | | | | | 11.4 | 7.5 | 7.5 | 7.5 | 7.5 | 7.5 | 7.5 | 7.5 |
| DIPPT + pyrocatechol + TBC | 0.9 | 0.9 | 0.8 | 0.8 | 0.8 | 0.8 | 0.8 | 0.8 | 0.8 | 0.8 | 0.8 | 0.8 | 0.8 | 0.8 |
| Degree of filling*) [wt. %] | 65.5 | 65.5 | 70 | 70 | 70 | 70 | 70 | 70 | 70 | 70 | 70 | 70 | 70 | 70 |
| τ [N/mm²] | 31.9 | 35.6 | 35.5 | 37.3 | 35.9 | 34.5 | 37.3 | 37.4 | 36.9 | 38.3 | 39.3 | 38.0 | 36.9 | 37.3 |

| Example | 26 | 27 | 28 | 29 | 30 | 31 | 32 | 33 | 34 | 35 | 36 | 37 | 38 |
|---|---|---|---|---|---|---|---|---|---|---|---|---|---|
| SILBOND ® 600 MST | 3 | 2 | 1 | 15 | 15 | 15 | 15 | 15 | 15 | 24.5 | 24.5 | 24.5 | 15 |
| F32 | 46.1 | 47.1 | 48.1 | 34.1 | 34.1 | 34.1 | 34.1 | 34.1 | 34.1 | 24.5 | 24.5 | 24.5 | 34.1 |
| mUMA | 9.9 | 9.9 | 9.9 | 9.9 | 9.9 | 11.1 | 11.1 | 11.1 | 11.1 | 9.9 | 9.9 | 9.9 | 9.9 |
| HPMA | 4.6 | 4.6 | 4.6 | 4.6 | 4.6 | 4.6 | 4.6 | 4.6 | 4.6 | 4.6 | 4.6 | 4.6 | 4.6 |
| BDDMA | 7.2 | 7.2 | 7.2 | 8.7 | 8.7 | 10.5 | 7.5 | 10.5 | 7.5 | 7.2 | 8.7 | 10.2 | 11.7 |
| TCDDMA | 7.5 | 7.5 | 7.5 | 3 | | | | | | | | | |
| E2BADMA | | | | | 6 | | | | | | | | 3 |
| E4BADMA | | | | 3 | | | | | | 7.5 | 6 | 4.5 | |
| PEG200DMA | | | | | | 3 | 6 | | | | | | |
| HDDMA | | | | | | | | 3 | 6 | | | | |
| DIPPT + pyrocatechol + TBC | 0.8 | 0.8 | 0.8 | 0.8 | 0.8 | 0.8 | 0.8 | 0.8 | 0.8 | 0.8 | 0.8 | 0.8 | 0.8 |
| Degree of filling*) [wt. %] | 70 | 70 | 70 | 70 | 70 | 70 | 70 | 70 | 70 | 70 | 70 | 70 | 70 |
| τ [N/mm²] | 33.5 | 34.5 | 34.3 | 38.1 | 35.9 | 36.5 | 37.4 | 37.3 | 36.4 | 36.2 | 36.8 | 37.2 | 38.9 |

| Example | 39 | 40 | 41 | 42 | 43 | 44 | 45 | 46 | 47 | 48 | 49 | 50 |
|---|---|---|---|---|---|---|---|---|---|---|---|---|
| SILBOND ® 600 MST | 15 | | 15 | 15 | 15 | 15 | 15 | | | 15 | 15 | 15 |
| mod. SIKRON ® SF800 | | 15 | | | | | | | | | | |
| mod. SIKRON ® SF500 | | | | | | | | 15 | 5 | | | |
| F32 | 34.1 | 34.1 | 34.1 | 34.1 | 34.1 | 34.1 | 34.1 | 34.1 | 44.1 | 34.1 | 34.1 | 34.1 |
| mUMA | 9.9 | 9.9 | | | | | | 9.9 | 9.9 | 9.9 | | |
| TUMA | | | | | | | 12 | | | | | |
| XUMA | | | | | | 12.9 | | | | | | |
| bisGMA | | | | | | | | | | | 9.9 | 9.9 |
| HPMA | 4.6 | 4.6 | 4.6 | 4.6 | 4.6 | 4.6 | 4.6 | 4.6 | 4.6 | 4.6 | 4.6 | 4.6 |
| BDDMA | 10.2 | 7.2 | 6.6 | 4.2 | 5.7 | 7.2 | 8.1 | 7.2 | 7.2 | 8.7 | 8.7 | 8.7 |
| TCDDMA | | 7.5 | | 4.5 | | 4.5 | 4.5 | 7.5 | 7.5 | 6 | 6 | |
| E2BADMA | 4.5 | | 18 | 15.9 | 15.9 | | | | | | | |
| E3BADMA | | | | | | | | | | | | 6 |
| E4BADMA | | | | | 3 | | | | | | | |
| DIPPT + pyrocatechol + TBC | 0.8 | 0.8 | 0.8 | 0.8 | 0.8 | 0.8 | 0.8 | 0.8 | 0.8 | 0.8 | 0.8 | 0.8 |
| Degree of filling*) [wt. %] | 70 | 70 | 70 | 70 | 70 | 70 | 70 | 70 | 70 | 70 | 70 | 70 |
| τ [N/mm²] | 35.9 | 36.9 | 32.6 | 33 | 34.0 | 35.3 | 34.8 | 34.1 | 33.3 | 33.3 | 35.1 | 34.1 |

*)Total amount of all inorganic solids

1: A reactive resin component, comprising:
at least one radically curable unsaturated compound,
at least one filler made of at least one oxide of silicon, wherein the at least one filler is modified with a silane that has reactive groups capable of polymerization with the at least one radically curable unsaturated compound, and
optionally, at least one other different inorganic additive,
wherein a proportion of all inorganic solids in the reactive resin component is at least 60 wt. % and wherein a proportion of the at least one filler which has a grain diameter of 4 μm or smaller is 0.5 to 60 wt. %, based on the reactive resin component.

2: The reactive resin component according to claim 1, wherein the at least one filler is silicon dioxide in the additional presence of one or more metal oxides.

3: The reactive resin component according to claim 1, wherein the silane is selected from the group consisting of 3-(meth)acryloyloxypropyltrimethoxysilane, 3-(meth)acryloyloxypropyltriethoxysilane, 3-(meth)acryloyloxymethyltrimethoxysilane, 3-(meth)acryloyloxymethyltrimethoxysilane, vinyltrimethoxysilane, vinyltriethoxysilane, tetraethoxysilane, tetramethoxysilane, and tetrapropoxysilane.

4: The reactive resin component according to claim 1, wherein the at least one radically curable unsaturated compound comprises:
35 wt. % or more, based on the reactive resin component, of a compound having at least two carbon-carbon double bonds, a weight-average molecular weight of which per carbon-carbon double bond (WPU) is greater than 230 g/mol and a viscosity of which is greater than 2500 mPa·s (measured in accordance with DIN 53019 at 25° C.).

5: The reactive resin component according to claim 4, wherein the compound having at least two carbon-carbon double bonds, the weight-average molecular weight of which per carbon-carbon double bond (WPU) is greater than 230 g/mol and the viscosity of which is greater than 2500 mPa·s (measured in accordance with DIN 53019 at 25° C.), is a compound based on urethane (meth)acrylate, a compound based on epoxy (meth)acrylate, a compound based on a methacrylate of an alkoxylated bisphenol, or a compound based on other unsaturated compounds.

6: The reactive resin component according to claim 1, wherein the at least one radically curable compound comprises:
30 wt. % or more, based on the reactive resin component, of a first compound having at least two carbon-carbon double bonds, a weight-average molecular weight of which per carbon-carbon double bond (WPU) is greater than 230 g/mol and a viscosity of which is greater than 2500 mPa·s (measured in accordance with DIN 53019 at 25° C.), and
10 wt. % or more, based on the reactive resin component, of a second compound having at least two carbon-carbon double bonds, a weight-average molecular weight of which per carbon-carbon double bond (WPU) is greater than 125 g/mol and a viscosity of which is less than 2500 mPa·s (measured in accordance with DIN 53019 at 25° C.);
or
57 wt. % or more, based on the reactive resin component, of a third compound having at least two carbon-carbon double bonds, a weight-average molecular weight of which per carbon-carbon double bond (WPU) is greater than 225 g/mol and a viscosity of which is less than 2500 mPa·s (measured in accordance with DIN 53019 at 25° C.);
or
50 wt. % or more, based on the reactive resin component, of the third compound having at least two carbon-carbon double bonds, the weight-average molecular weight of which per carbon-carbon double bond (WPU) is greater than 225 g/mol and the viscosity of which is less than 2500 mPa·s (measured in accordance with DIN 53019 at 25° C.), and
10 wt. % or more, based on the reactive resin component, of the second compound having at least two carbon-carbon double bonds, the weight-average molecular weight of which per carbon-carbon double bond (WPU) is greater than 125 g/mol and the viscosity of which is less than 2500 mPa·s (measured in accordance with DIN 53019 at 25° C.).

7: The reactive resin component according to claim 6, wherein the third compound having at least two carbon-carbon double bonds, the weight-average molecular weight of which per carbon-carbon double bond (WPU) is greater than 225 g/mol and the viscosity of which is less than 2500 mPa·s (measured in accordance with DIN 53019 at 25° C.) is selected from the group consisting of tricyclodecane dimethanol diacrylate, ethoxylated bisphenol A dimethacrylate, and ethoxylated glycol dimethacrylate.

8: The reactive resin component according to claim 1, further comprising at least one accelerator and at least one inhibitor.

9: The reactive resin component according to claim 1, further comprising a hydraulically setting or polycondensable compound.

10: The reactive resin component according to claim 1, further comprising at least one other inorganic and/or organic aggregate.

11: A multi-component reactive resin system, comprising:
the reactive resin component according to claim 1, and
a hardener component which comprises a curing agent for the at least one radically curable unsaturated compound.

12: A method for enhancing performance of a reactive resin component, comprising:
mixing at least one filler and at least one compound having at least two carbon-carbon double bonds, to obtain a reactive resin component for chemical fastening,
wherein the at least one filler is made of at least one oxide of silicon, wherein the at least one filler is modified with a silane that has reactive groups capable of polymerization with a radically curable unsaturated compound, and wherein the at least one filler optionally comprises other different inorganic additives, wherein a proportion of the at least one filler which has a grain diameter of 4 μm or smaller is 0.5 to 60 wt. %, based on the reactive resin component, and
wherein the at least one compound having at least two carbon-carbon double bonds has a weight-average molecular weight of which per carbon-carbon double bond (WPU) is greater than 225 g/mol and a viscosity of which is less than 2500 mPa·s (measured in accordance with DIN 53019 at 25° C.).

13: The method according to claim 12, wherein the at least one compound having at least two carbon-carbon double bonds is selected from the group consisting of tricyclodecane dimethanol diacrylate, ethoxylated bisphenol A dimethacrylate, and ethoxylated glycol dimethacrylate.

14: The method according to claim 12, wherein the at least one filler is silicon dioxide in the additional presence of one or more metal oxides.

15: The reactive resin component according to claim 2, wherein the silicon dioxide is quartz or a silicate, and wherein a metal of the one or more metal oxides is selected from the group consisting of calcium, titanium, iron, and sodium.

16: The method according to claim 14, wherein the silicon dioxide is quartz or a silicate, and wherein a metal of the one or more metal oxides is selected from the group consisting of calcium, titanium, iron, and sodium.
